(19) United States
(12) Patent Application Publication
(10) Pub. No.: US 2004/0185901 A1
(43) Pub. Date: Sep. 23, 2004

(54) Electronic device for wireless communications and reflector device for wireless communication cards

(75) Inventors: Hideki Kachi, Tokyo (JP); Takayuki Kasuya, Tokyo (JP)

Correspondence Address: MCGINN & GIBB, PLLC, 8321 OLD COURTHOUSE ROAD, SUITE 200, VIENNA, VA, 22182-3817, US

(73) Assignee: TDK Corporation, Tokyo (JP)

(21) Appl. No.: 10/801,698

(22) Filed: Mar. 17, 2004

(30) Foreign Application Priority Data
Mar. 18, 2003 (JP) 2003-072951
May 15, 2003 (JP) 2003-136895

(51) Int. Cl. H04M 1/00

(52) U.S. Cl. 455/556.1; 455/557

(57) ABSTRACT

An electronic device for wireless communications, which may typically be a PC card 21, is adapted to upwardly turn the direction of radiation of the radio wave radiated from an antenna regardless of the mounted position of the antenna. The PC card 21 is contained in or removably fitted to a personal computer 11 so as to provide the personal computer 11 with wireless communication functions. The PC card 21 comprises amounting base board 24 fitted to the personal computer 11 with an end thereof projecting from the personal computer 11 and mounting a wireless 10 circuit, at least a chip antenna 23 arranged at the projecting region of the mounting base board 24 and electronically connected to the wireless circuit and a reflector 28 arranged below the chip antenna 23 and a housing covering the mounting base board 24, and adapted to upwardly reflect at least part of the radio wave that is radiated from the chip antenna 23 and directed downward.

### BACKGROUND OF THE INVENTION

This invention relates to an electronic device for wireless communications, such as a wireless communication card that provides an electronic apparatus, such as a personal computer with wireless communication functions. More particularly, this invention relates to a technology that can suitably be used to improve the radiation characteristics of an antenna arranged at the electronic device for wireless communications.

Currently, electronic apparatus including personal computers can be wirelessly connected to peripheral equipments including printers and also to communication networks such as the Internet by way of a wireless LAW (local area network) so as to provide a great convenience.

Means for providing the electronic apparatus with wireless communication functions include externally attachable electronic devices for wireless communications such as wireless communication cards of, for example PC cards, CF cards, SD cards and USB adapters and those contained in the electronic apparatus. An electronic device for wireless communications includes an antenna that is fitted to, for example a personal computer so as to project from the personal computer. Communication takes place as a radio wave that carries signals are radiated toward and from the personal computer by way of the antenna and a wireless circuit. An antenna that is used with an electronic device for wireless communications is normally mounted on a mounting base board and contained in a housing and has a radiation pattern that is directed upward when the mounting surface thereof is directed upward.

Some electronic devices for wireless communications are provided with a plurality of antennas contained in a housing in order to meet the requirement of multi-band. For example, there are some electronic devices for communications provided with two antennas, one for the 2.4 GHz band and the other for the 5 GHz band, that are contained in a single housing. As two or more than two antennas are mounted on the mounting base board for different frequencies, the area of the mounting base board that is occupied by the antennas inevitably increases.

Japanese Patent Application Laid-Open Publication No. H8-204621 discloses a technique of mounting antenna on both the front surface and the rear surface of a mounting base board for the purpose of suppressing the area of the mounting base board that is occupied by the antennas and improving the mounting efficiency.

However, with the proposed technique, some of the antennas of a personal computer that is provided with an electronic device for wireless communications show a downwardly directed radiation pattern.

The radiation characteristics of the antenna showing a downwardly directed radiation pattern are highly disadvantageous particularly in terms of directivity of communication because of various obstacles and communication troubles can take place to disturb the environment for the use of the antenna and discomfort the user thereof.

Additionally, the radio wave radiated from an antenna having an upwardly directed radiation pattern can partly be directed downward. Good conditions for communications can be realized by upwardly redirecting the downwardly directed radio wave.

Obstacles that block radio waves are found not only below an antenna but also in lateral directions relative to the antenna. While desks and tables may be found below antennas, walls and furniture may constitute lateral obstacles to antennas. Good conditions for communications cannot be realized unless such obstacles are avoided.

On the other hand, the above-mentioned wireless communication card, such as a PC card, and the like is attached to a PC card slot formed in a personal computer, and the like and is used for data communications with the other electronic apparatus. It is necessary that an antenna used in the wireless communication card is fabricated to be thin in size. Therefore, not only many planar antennas, such as inverted-F antennas, but also many capacity loaded monopole antennas and micro strip antennas are used as the antennas for the wireless communication cards. Japanese Patent Application Laid-open Publication No. 2001-243435 discloses such an antenna for the wireless communication card.

In the interim, these antennas have ground planes in the structures thereof. Consequently, radio waves cannot be radiated in the direction of the ground planes in the antennas. Accordingly, radiation patterns are directed vertically upward or inclined upward from an upper surface of the wireless communication card. in many antennas used for the wireless communication cards. Radiation patterns directed downward therefore become weak in the antennas. As a result, when wireless communication is carried out between personal computers positioned at two points having a difference in height, for example, between first and second floors, strength of radio waves inevitably becomes weak in an antenna used for the wireless communication card of the personal computer positioned at the second floor. Subsequently, quality of communication is sometimes deteriorated.

Besides, proposals for solving the above problem are made in Japanese Patent Application Laid-Open Publication No. H9-259238 and Japanese Utility Model Registered Publication No. 3050211. These Publications disclose that the direction of an antenna can be adjusted to have an optimized receiving condition by rotatably adapting an antenna portion to a body of a wireless communication card.

In addition, the other proposal is made in Japanese Patent Application Laid-Open Publication No. H11-S3498. The Publication discloses an antenna that a planar antenna is located in a semi-circular plate and that a guide is formed to surround the planar antenna. Further, the antenna has a reflector device which can be moved in line with the guide. With the structure, the antenna is capable of reducing influence of multi-pass by adjusting a position of the reflector device.

Thus, directions of radiation patterns cannot be varied in most of wireless communication cards each including a planar antenna. As a result, in a case that an electronic apparatus, and the like of a wireless communication partner are located in the direction different from those of the radiation patterns, quality of communication is sometimes deteriorated.

On the other hand, let a location of an electronic apparatus, such as a personal computer be changed on a condition that a wireless communication card is attached to the electronic apparatus. So, radiation patterns of an antenna used in the wireless communication card may be determined in the desirable direction and thereby quality of communication may be maintained. However, since the location of the electronic apparatus is required to be thus changed, the electronic apparatus becomes inconvenient for use.

Under the circumstances, if a user purchases a new wireless communication card including a rotatable antenna portion or a pivoted reflector device and replaces the old (existing) one with the new wireless communication card, the user can vary the direction of the radiation patterns or reduce influence of multi-pass. However, the old (existing) wireless communication card inevitably becomes useless in such a case.

### SUMMARY OF THE INVENTION

It is therefore an object of the present invention to provide a device for wireless communications that is adapted to shift the direction of radiation of the radio wave radiated from an antenna by reflection regardless of the mounted position of the antenna.

It is another object of the present invention to provide a reflector device for a wireless communication card which is capable of widely improving quality of wireless communication, even though the existing wireless communication card is used therefor.

Other objects of the present invention will become clear as the description proceeds.

According to an aspect of the present invention, there is provided an electronic device for wireless communications contained in or removably fitted to an electronic apparatus so as to provide the electronic apparatus with wireless communication functions, the electronic device comprising: a projecting section fitted to the electronic apparatus with an end thereof projecting from the electronic apparatus; at least an antenna arranged at the projecting section and electronically connected to a wireless circuit; and a reflection means for shifting at least part of the radiating directions of the radio wave radiated from the antenna.

With this invention, the radiating directions of the radio wave radiated from the antenna are shifted by a reflection means so as to prevent the radio wave from being blocked by obstacles regardless of the surface of the mounting base board on which the antenna is mounted. Therefore, it is now possible to realize good conditions for communications.

In a preferred mode of carrying out the invention, the reflection means can rotate around a pivot.

With this arrangement, the angle of reflection of the radio wave radiated from the antenna can be shifted by shifting the rotary angle of the reflection means. In other words, the angle of reflection of the reflection means can be regulated to realize a better radiation.

In a further preferred mode of carrying out the invention, the reflection means can be made to change positions thereof from a first position capable of reflecting the radio wave radiated from the antenna to a second position incapable of reflecting the radio wave.

With this arrangement, the angle of reflection of the radio wave radiated from the antenna can be shifted and it is possible to selectively adapt the antenna to a situation where the radio wave needs to change directivity thereof and to a situation where the radio wave does not need to change the directivity thereof.

In a further preferred mode of carrying out the invention, each of bearings supporting the pivots is provided with an oblong hole adapted to rotatably support the corresponding pivot at a plurality of vertically arranged positions.

With this arrangement, the pivot of the reflection means can be moved vertically so that the freedom with which the radio wave radiation pattern can be regulated by way of the reflection means is broadened.

In a further preferred mode of carrying out the invention, the reflection means is integral with a housing that covers the mounting base board.

With this arrangement, the reflection means becomes integral with the housing when the reflection means is closed so that the user can carry the electronic device for wireless communications with ease and the electronic device is prevented from being damaged.

In a further preferred mode of carrying out the invention, the reflection means can swing in any direction around a pivot formed as a result of engagement of a spherical projection and a spherical recess.

With this arrangement, the angle of reflection of the radio wave radiated from the antenna can be shifted in any direction so that it is possible to regulate the angle of the reflection means so as to provide optimal radiating conditions.

In a further preferred mode of carrying out the invention, the reflection surface of the reflection means is curved so as to be convex or concave.

With this arrangement, the reflection means can radiate radio waves more broadly and cover a broader area to sensitively receive radio waves.

In a further preferred mode of carrying out the invention, the reflection surface of the reflection means is provided with a large number of projections.

With this arrangement, a radio wave is randomly reflected by the reflection means to provide a broadly diffused radiation pattern.

In a further preferred mode of carrying out the invention, the antenna is arranged on the mounting base board of the projecting section and located at a position higher than a circuit mounting region where the wireless circuit is mounted.

With this arrangement, the gap separating the antenna and the reflection means can be broadened so that the operation of regulating the sensitivity will become easier and the influence of noise from the electronic apparatus will be alleviated.

In a further preferred mode of carrying out the invention, the reflection means is removably fitted to the housing.

With this arrangement, an electronic device for wireless communications that originally does not have a reflection means can be provided with a reflection means at any time.

According to another aspect of the present invention, there is also provided a reflector device for use in a wireless communication card, comprising: a base portion which has an attachment portion attached to said wireless communication card; and a reflector which is rotatably attached to said base portion through a movable supporting portion and which reflects a radio wave. By attaching the reflector device to a wireless communication card, a reflector can be provided with an antenna included in the wireless communication card. Further, by changing a direction of the reflector, a direction of radiation patterns (directivity characteristics) can be changed. Namely, by adjusting the direction of the reflector and thereby changing the direction of radiation patterns to an electronic apparatus of a wireless communication partner, quality of communication can be improved and thereby good communication can be carried out.

It is preferable that the attachment portion has a structure capable of being attached to and removed from the wireless communication card. With the structure, the reflector device can be attached to a wireless communication card, when a direction of radiation patterns is required to be changed. On the other hand, when a location of a users electronic apparatus, such as a personal computer or a location of an electronic apparatus of the wireless communication partner is changed and thereby a direction of radiation patterns is not required to be changed, the reflector device can be removed from the wireless communication card.

It is preferable that the movable supporting portion has a structure that the reflector is supported by the movable supporting portion with the reflector capable of being freely risen and felled. By rising or falling the reflector, the direction of the radiation patterns can be changed upward or downward.

It is also preferable that the movable supporting portion has a structure that the reflector is supported by the movable supporting portion with the reflector capable of being freely rotated. By rotating the reflector, the direction of the radiation patterns can be changed sideward.

It is yet also preferable that the movable supporting portion has a structure that the reflector is supported by the movable supporting portion with the reflector capable of not only being freely risen and felled but also being freely rotated. By rising, falling or rotating the reflector, the radiation patterns can be optionally determined in any directions.

The reflection surface of said reflector may be formed by a planar surface. on the contrary, the reflection surface of said reflector may be formed by a curved surface.

It is possible that the radiation patterns are arranged to be comparatively wide (broad) by forming the reflection surface of the reflector to have a planar surface. On the other hand, it is possible that the radiation patterns are arranged to be not only comparatively narrow (sharp) but also further wide (further broad) by forming the reflection surface of the reflector to have a curved surface, such as a parabolic surface, and the like.

At least one projection (for example, a spherical projection or a pyramidal projection) may be formed in a surface of said reflection surface of said reflector device, so that reflection efficiency is thereby improved.

### BRIEF DESCRIPTION OF THE DRAWINGS

FIG. 1 is a schematic perspective view of a PC card according to the invention and a personal computer provided with an expansion slot for receiving the PC card;

FIG. 2 is a partly cut out perspective view of an embodiment of the present invention that is a PC card;

FIG. 3 is a perspective view of the PC card of FIG. 2 as viewed from a different angle;

FIG. 4 is a schematic illustration of the angle of radiation of radio wave of the PC card of FIG. 2;

FIG. 5 is a schematic perspective view of a principal part of another embodiment of the present invention that is also a PC card;

FIG. 6 is a schematic perspective view of a principal part of still another embodiment of the present invention that is also a PC card;

FIG. 7 is a schematic perspective view of the PC card of FIG. 6, where the angle of the reflector is shifted from that of FIG. 6;

FIG. 8 is a schematic perspective view of the PC card of FIG. 6, where the angle of the reflector is further shifted from that of FIG. 6;

FIG. 9 is a schematic perspective view of a principal part of still another embodiment of the present invention that is also a PC card;

FIG. 10 is a schematic perspective view of a principal part of still another embodiment of the present invention that is also a PC card;

FIG. 11 is a schematic perspective view of a reflector device for wireless communication card according to a yet another embodiment of the present invention;

FIG. 12 is a side view of the reflector device for wireless communication card according to the yet another embodiment of the present invention;

FIG. 13 is a front view of the reflector device for wireless communication card according to the yet another embodiment of the present invention;

FIG. 14 is a view for schematically showing an example of the reflector device for wireless communication card according to the yet another embodiment of the present invention, by which radiation patterns of the antenna are changed to be directed downward;

FIG. 15 is a view for schematically showing an example of the reflector device for wireless communication card according to the yet another embodiment of the present invention, by which radiation patterns of the antenna are changed to be directed sideward;

FIG. 16 is a schematic perspective view of a PC card and a reflector device for wireless communications, where directions in which the reflector device is adapted to the PC card are depicted.

FIG. 17 are explanation views for schematically showing various methods for adapting a reflector device to a PC card with the reflector device capable of being removed from the PC card;

FIG. 18 is a schematic perspective view of a first example of a structure that reflector devices for wireless communications are contained in the personal computer;

FIG. 19 is a schematic perspective view of a second example of a structure that reflector devices for wireless communications are contained in the personal computer;

FIG. 20 is a schematic perspective view of a third example of a structure that a reflector device for wireless communications is contained in an Access Point apparatus and that the reflector device for wireless communications can be drawn from the Access Point apparatus with a slid structure thereof; and

FIG. 21 is a schematic perspective view of a reflector device for wireless communications according to a still yet another embodiment of the present invention, in which the reflector device can be attached to and removed from an electronic apparatus, such as personal computer, access point apparatus, printer, and the like.

### DETAILED DESCRIPTION OF THE PREFERRED EMBODIMENTS

Now, preferred embodiments of the present invention will be described in greater detail by referring to the accompanying drawings. Throughout the drawings, the identical members are denoted respectively by the same reference symbols and will not be described repeatedly While the embodiments of the present invention as described herein are particularly preferred ones, the present invention is by no means limited thereto.

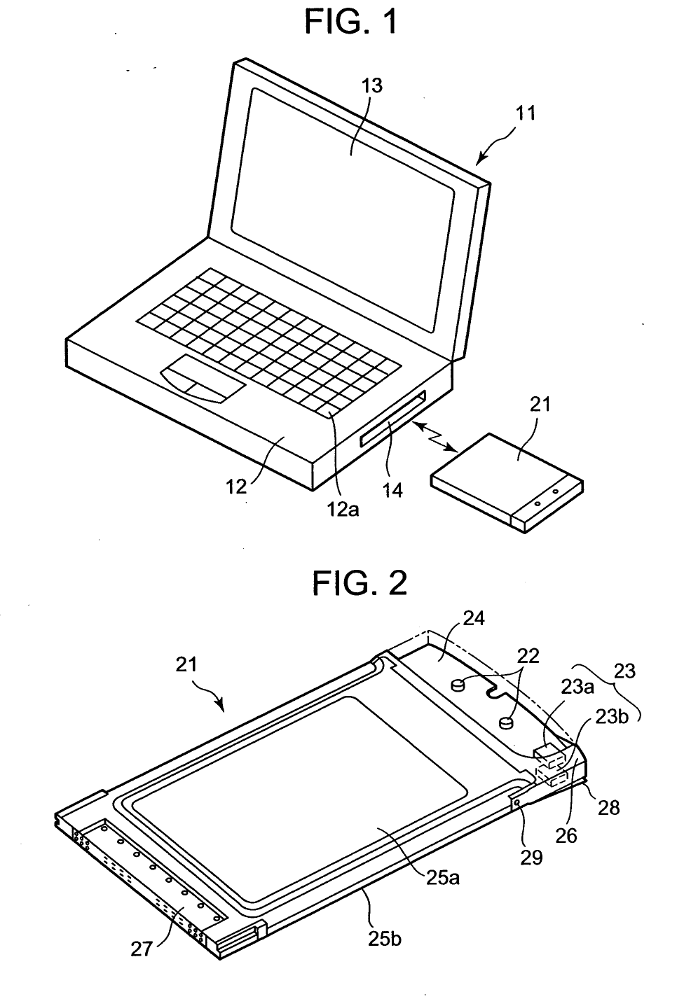

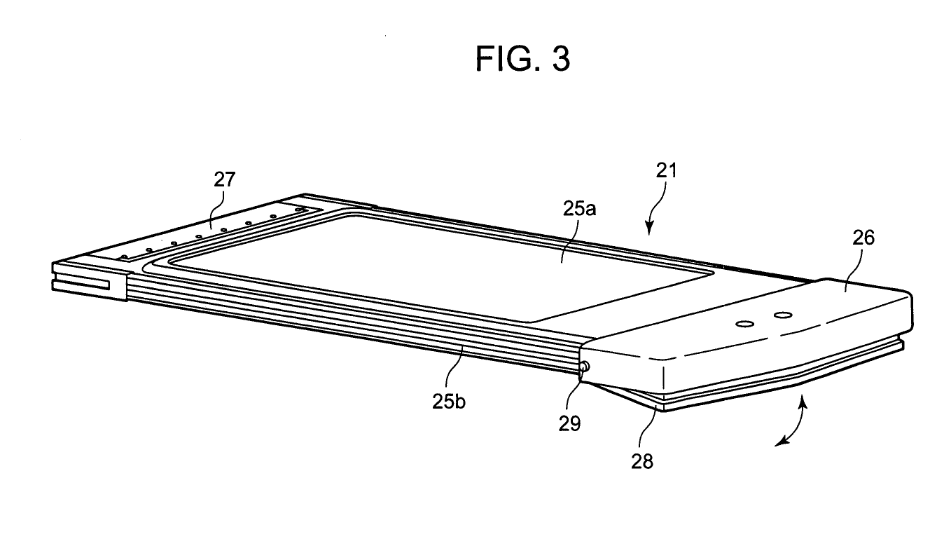

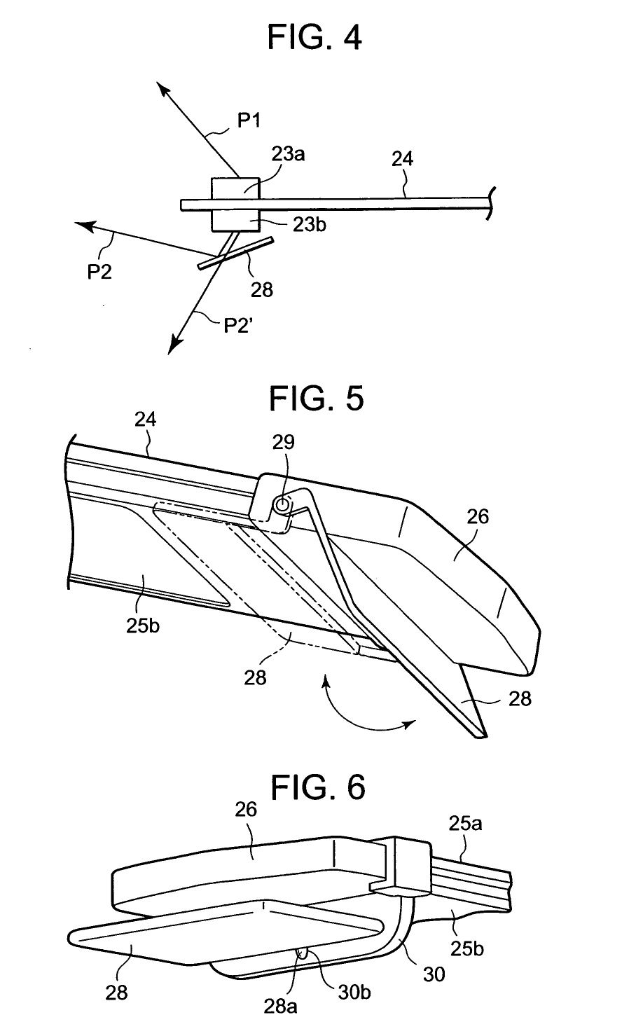

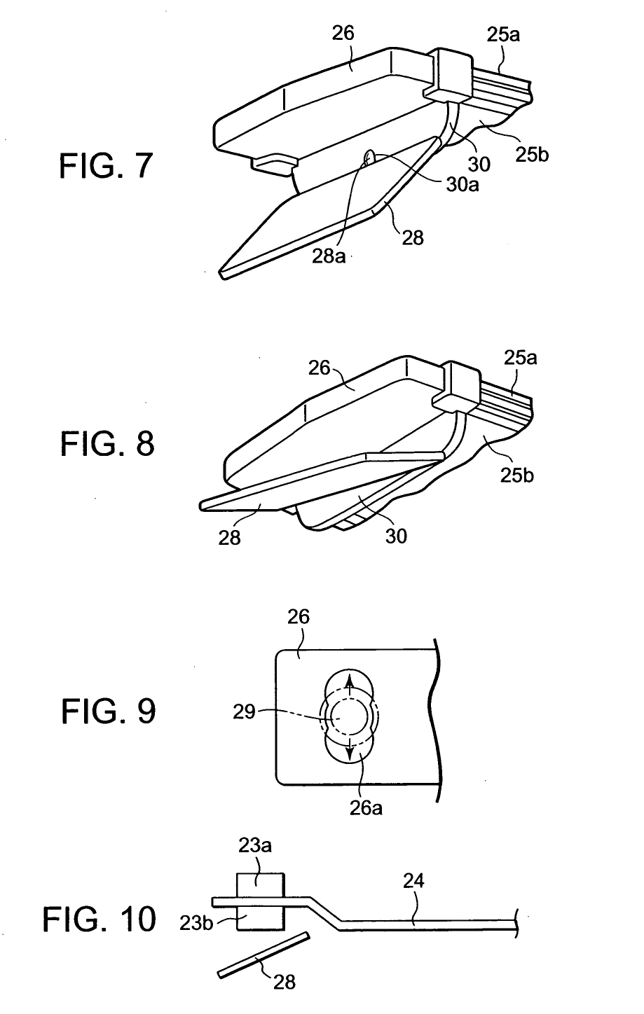

FIG. 1 is a schematic perspective view of a PC card according to the invention and a personal computer provided with an expansion slot for receiving the PC card. FIG. 2 is a partly cut out perspective view of an embodiment of the present invention that is a PC card. FIG. 3 is a perspective view of the PC card of FIG. 2 as viewed from a different angle. FIG. 4 is a schematic illustration of the pattern of radiation of radio wave of the PC card of FIG. 2. FIG. 5 is a schematic perspective view of a principal part of another embodiment of the present invention that is also a PC card. FIG. 6 is a schematic perspective view of a principal part of still another embodiment of the present invention that is also a PC card. FIG. 7 is a schematic perspective view of the PC card of FIG. 6, where the angle of the reflector is shifted from that of FIG. 6. FIG. 8 is a schematic perspective view of the PC card of FIG. 6, where the angle of the reflector is further shifted from that of FIG. 6. FIG. 9 is a schematic perspective view of a principal part of still another embodiment of the present invention that is also a PC card. FIG. 10 is a schematic perspective view of a principal part of still another embodiment of the present invention that is also a PC card.

Referring to FIG. 1, a portable personal computer 11 comprises a main body 12, which contains various electronic components (not shown) and has an input section including a keyboard 12a, and a display section 13 composed of a liquid crystal panel. The main body 12 is provided at a lateral side thereof with a PC card slot (expansion slot) 14, into which a PC card 21 for wireless communications (electronic device for wireless communications) can be removably inserted. The computer maybe any of various different portable information terminals other than a personal computer.

The PC card 21 provides the personal computer 11 with wireless communication functions. A wireless circuit (not shown) having various electronic components is mounted on the PC card 21. As shown in FIG. 2, the PC card 21 is provided with a mounting base board 24, at the front end of which LEDs 22 and a chip antenna (antenna) 23 are arranged. The LEDs 22 are adapted to indicate operating conditions of the PC card 21, whereas the chip antenna 23 is a signal receiving/transmitting means that is connected to the wireless circuit. A base board of the mounting base board 24 is, for example, a PWB (Printed Wiring Board), a PCB (Printed Circuit Board), or the like.

The part of the mounting base board 24 where the electronic components are mounted is covered at opposite sides thereof respectively by shield covers 25a, 23b that are made of metal such as SUS (Steel Use Stainless) in order to shield the electronic components. The front end (projecting region) of the mounting base board 24 where the chip antenna 23 is arranged is covered by a cover 26 that is made of a resin material such as PBT (Polytylenie Tereplithalate) and constitutes a projecting section (extended section) that externally projects from the PC card slot 14 when the PC card 21 is inserted into the PC card slot 14. The shield covers 25a, 25b covering the mounting base board 24 and the resin-made cover 26 form a housing. While the part covered and shielded by the metal-made shield covers 25a, 25b and the projecting section are realized by a single mounting base board 24 in this embodiment, the present invention is by no means limited thereto. Alternatively, a plurality of mounting base boards may be used. For example, a separate mounting base board may be used for the projecting section and connected to the major mounting base board by way of a flexible printed board.

A connector 27 is arranged at the end of the PC card 21 opposite to the extended section for the purpose of electronically connecting the PC card 21 to the personal computer 11 when the PC card 21 is inserted into the PC card slot 14. As the LPDs 22, the chip antenna 23 and the connector section 27 are mounted on the mounting base board 24, the shield covers 25a, 25b and the resin-made cover 26 are rigidly secured to the mounting base board 24 to produce a complete PC card 21.

The chip antenna 23 is realized by forming a radiation electrode on the main surface of the base board that is a dielectric body for high frequencies made of a ceramic dielectric material typically showing a specific dielectric constant [symbol] of about 37. The chip antenna 23 includes a first chip antenna 23a that is mounted on one of the opposite surfaces of the mounting base board 24 and a second chip antenna 23b that is mounted on the other surface of the mounting base board 24 for the purpose of suppressing the area of the mounting base board 24 that is occupied by the antennas and improving the mounting efficiency. The area of the radiation electrode of the first chip antenna 23a mounted on one of the opposite surfaces of the mounting base board 24 and that of the radiation electrode of the second chip antenna 23b mounted on the other surface of the mounting base board 24 differ from each other and hence the two chip antennas 23a, 23b have respective frequency bands that are different from each other. For example, the frequency band of the first chip antenna 23a may be 2.4 GHz band, whereas that of the second chip antenna 23b may be 5 GHz. With the above described mounting mode of this embodiment of PC card 21 that is adapted to be inserted into the PC card slot 14 with mounting surface of the first chip antenna 23a facing upward, the radiation pattern of the first chip antenna 23a is upwardly directed, whereas that of the second chip antenna 23b is downwardly directed (see FIG. 4).

Referring now to FIG. 3, a reflector (reflection means) 28 is arranged below the chip antenna 23 so as to upwardly reflect the radio wave downwardly radiated from the second chip antenna 23b and the downwardly directed part of the radio wave radiated from the first chip antenna 23a. In short, the reflector 28 upwardly reflects any downwardly directed radio wave radiated from the chip antenna 23.

The reflector 28 is made of a metal material that can reflect radio waves such as Al (aluminum), Fe (iron) or SUS (Steel Use Stainless), gold, silver, or formed by a resin plate and the like whose opposite surfaces are plated with metal. It is fitted to the housing by way of a pair of pivots 29 that are arranged respectively at the opposite lateral sides of the PC card 21 and extend substantially horizontally. Thus, the reflector 28 can rotate around the pivots 29.

As shown in FIG. 4, the reflector 28 constitutes a part of the housing and is inclined relative to the main surface of the antenna 23 provided with radiation electrodes by a predetermined angle even when the reflector is closed and hence held to a state closest to a horizontal posture. The angle of inclination of the reflector 28 can be regulated by turning it around the spindles. The reflector 28 may be held to a desired angle by applying a load to the pivots 29 or by providing the reflector 28 with a latch section. The reflector 28 may alternatively be made to be a part that is separated and independent from the housing.

In FIG. 4, reference symbol P1 denotes the direction of radiation of the first chip antenna 23a and reference symbol P2 denotes the direction of radiation of the second chip antenna 23b after the radio wave radiated from the second chip antenna 23b is reflected by the reflector 28, while reference symbol P2′ denotes the direction of radiation of the second chip antenna 23b when the reflector 28 is not provided.

As seen from FIG. 4, the radio wave that may be downwardly radiated from the chip antenna 23 is upwardly reflected by the reflector 28 that is inclined relative to the main surface of the base member of the chip antenna 23. As a result, any radio wave is upwardly radiated from the chip antenna 23 regardless if the chip antenna 23 is mounted on which surface of the mounting base board 24.

The reflector 28 can rotate as pointed out above. Therefore, the radio wave radiated from the chip antenna 23 is upwardly reflected in a direction close to the vertical direction when the angle formed by the reflector 28 and the main surface of the base member of the chip antenna 23 is made small, whereas the radio wave radiated from the chip antenna 23 is reflected in a direction close to the horizontal direction when the angle formed by the reflector 28 and the main surface of the base member of the chip antenna 23 is made large. In this way, the angle of reflection of the radio wave downwardly radiated from the chip antenna 23 can be shifted by shifting the rotary angle of the reflector 28 so that the angle of inclination of the reflector 28 can be regulated to realize an optimal state of radiation.

Additionally, since the reflector 28 constitutes a part of the housing, it comes to be integrally combined with the housing so as to be prevented from being damaged when it is closed to a great convenience on the part of the user who may want to carry it.

Note that the reflector 28 is separated from the chip antenna 23 by a predetermined gap interposed between them so as to prevent the radio waves radiated from the antenna 23 from blocking each other. Preferably, the reflector 28 has an area greater than the projection area of the radiation electrode formed on the underside second chip antenna 23b in order to upwardly maximally reflect the radio wave downwardly radiated from the second chip antenna 23b.

While the reflector 28 can be rotated in the case of the illustrated embodiment, it may be alternatively rigidly secured to show a predetermined angle relative to the main surface of the base member of the chip antenna 23. If the reflector 28 is made rotatable, it may be so arranged that the reflector 28 is held in parallel with the main surface of the base member of the chip antenna 23 when it is closed and comes to show a predetermined angle relative to the main surface of the base member when it is rotated.

The reflector 28 may have a structure as described below.

Referring to FIG. 5, the reflector 28 is made independent from the members of the housing and can take a first position (indicated by solid lines in FIG. 5) where it reflects the radio wave radiated from the chip antenna 23 and directed downward and a second position (indicated by dotted broken lines in FIG. 5) where it does not reflect any radio wave. Note that the first position is the position where the reflector 28 reflects radio wave and the second position is the position where it does not reflect any radio wave. They do not refer to the two positions that define the largest rotary angle.

With the above described structure, the reflector 28 is selectively placed at the second position when it does not need to shift the direction of the downwardly directed ratio wave and rotated from the second position to the first position when it needs to shift the direction of the downwardly directed radio wave. Since the reflector 28 is made independent from the housing, reflector 28 can be removed or replaced with ease in a servicing operation.

Referring to FIGS. 6 through 8, it may be so arranged that a base portion 30 that is provided with a spherical recess 30a is fitted to the housing and the reflector 28 is provided with a spherical projection 28a. The reflector 28 can be swung in any desired direction when the spherical projection 28a is engaged with the spherical recess 30a to form a pivot. Alternatively, the base portion 30 may be provided with a spherical projection while the reflector 28 is provided with a spherical recess.

As the reflector 28 can be removably fitted to the housing by way of the base portion 30 as shown in FIGS. 6 through 8, a PC card 21 that does not originally have a reflector 28 may be provided with a reflector 28 at any time. Besides, the base portion 30 has a pair of attachment portions 30A and 30B.

Referring to FIG. 9, each of the bearings supporting the pivots 29 (in FIG. 9, the resin-made cover 26 also operates as bearings) may be provided with an oblong hole 26a adapted to rotatably support the corresponding pivot 29 at a plurality of vertically arranged positions. With this arrangement, the pivots of the reflector 28 can be moved vertically to further increase the level of freedom with which the direction of radio wave radiation is regulated by means of the reflector 28.

While the reflection surface of the reflector 28 is generally planar, it may alternatively be curved so as to be convex or concave. A curved reflector surface can radiate radio waves more broadly and cover a broader area to sensitively receive radio waves. The reflection surface of the reflector 28 may be provided with a large number of projections (spherical projections, conical projections, etc.). Then, a radio wave is randomly reflected by the reflector 28 to provide a broadly diffused radiation pattern.

Referring to FIG. 10, the projecting region of the mounting base board 24 where the chip antenna 23 is arranged may be provided with a step so that the chip antenna 23 can be arranged at a level higher than the level of the circuit-mounting region where the wireless circuit is mounted. With this arrangement, the gap separating the chip antenna 23 and reflector 28 can be broadened so that the operation of regulating the sensitivity will become easier and the influence of noise from the personal computer 11 will be alleviated.

Note that, the vertical relations of the components in the above description are applicable to a situation where the PC card 21 is inserted into the PC card slot 14 and the user operates the personal computer 11. The expression of upwardly directed radiation of a radio wave as used herein refers to radiation that is directed both vertically upward and obliquely upward.

While the PC card slot 14 is arranged at a lateral side of the main body 12 of the personal computer 11 as shown in FIG. 1 in the above description of the embodiment, the present invention is by no means limited thereto. For example, the card slot may be formed at a lateral side of the display section 13 and the projecting section projects from there or the projecting section including the antenna that is contained in the personal computer 11 is arranged at a lateral side of the display section 13. In short, any modifications to the above described embodiment is justifiable so long as an electronic device for wireless communications according to the invention can be used to prevent obstacles such as desks and tables that may be located below the antenna and walls that may be located laterally relative to the antenna from blocking radio waves. In other words, the reflector 28 is only required to shift the direction of radiation of the radio wave radiated from the antenna and hence its role is not limited to upwardly reflecting a downwardly directed radio wave.

While a plurality of chip antennas 23 are provided to operate for frequencies that are different from each other in the above described embodiment, a single antenna that operates for different frequencies or a single antenna that operates for a single frequency may alternatively be used for the purpose of the invention.

It may be needless to say that an antenna other than a chip antenna can also be used for the purpose of the invention.

While an electronic device for wireless communications according to the present invention is described above in terms of an embodiment that is a PC card, the present invention is by no means limited thereto and can be embodied as a CF card, an SD card or a USB adaptor that is designed to be externally fitted to a computer or as a device contained in a computer.

As described above, the present invention provides the following advantages.

According to the invention, the direction of radiation of radio waves can be shifted by a reflection means not only when the antenna is arranged on the lower surface of the mounting base board, in which case the downwardly directed radio wave is directly reflected by the reflection means, but also when the antenna is arranged on the upper surface of the mounting base board, in which case the downwardly directed leak of radio wave is reflected by the reflection means. Thus, regardless of the surface where the antenna is mounted on the mounting base board, the radiated radio waves will no longer be blocked by obstacles and it is possible to provide good conditions for communications.

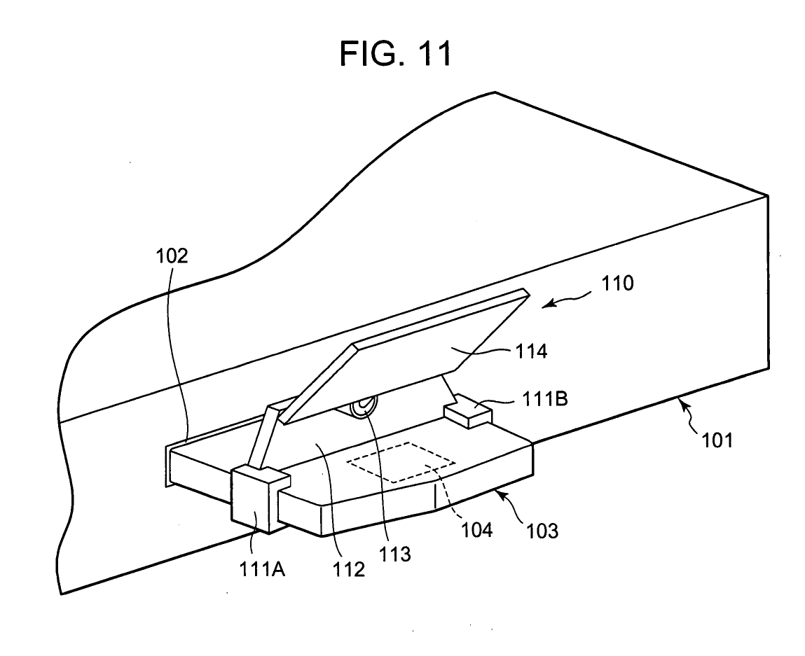

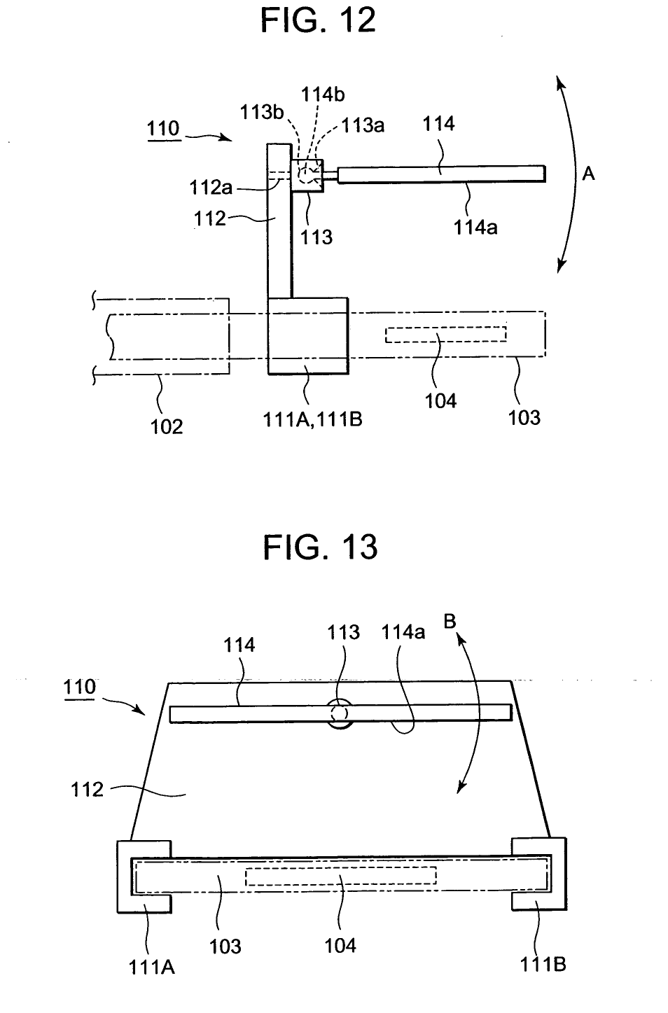

Next, referring to FIGS. 11 through 15, description will proceed to a reflector device for wireless communication card according to a yet another embodiment of the present invention. FIG. 11 is a schematic perspective view of the reflector device for wireless communication card according to the yet another embodiment of the present invention. FIG. 12 is a side view of the reflector device while FIG. 13 is a front view thereof.

FIG. 11 shows a condition that a wireless communication card 103 is inserted into a PC card slot 102 of a personal computer 101 of, for example note-book type and that a reflector device 110 for wireless communication card is attached to the wireless communication card 103.

As illustrated in FIGS. 11 through 13, the reflector device 110 for wireless communication card comprises a base portion 112 which has a pair of attachment portions 111A and 111B, and a reflector 114 which is rotatably attached to the base portion 112 through a movable supporting portion 113. The movable supporting portion 113 is composed, for example, of a cylindrical member and rotatably inserted into a hole 112a formed in the base Portion 112. Further, a spherical pivot 114b of the reflector 114 is rotatably fitted into a spherical recess 113b formed in the inner part of a nozzle-like opening portion 113a of the movable supporting portion 113. Besides, a plurality of holes 112a may be formed in the base portion 112 with the holes 112a having respective positions in height different from each other so that the movable supporting portion 113 may be optionally inserted into any of the holes 112a. With this structure, it becomes possible that a distance between the antenna 104 and a reflection surface (a surface opposite to the antenna 104) of the reflector 114 may be adjusted. Thereby, the structure of the reflector device 110 for wireless communication card can be applied to, for example, various types of wireless communication cards having different shapes of extended portions of the cards from each other. Besides, at least a reflection surface 114a of the reflector 114 is composed of a material capable of reflecting radio waves, such as Al (aluminum), Fe (iron) or SUS (Steel Use Stainless), gold, silver, or formed by a resin plate and the like.

As illustrated in FIGS. 12 and 13, the reflector 114 is located above the antenna 104 included in the wireless communication card 103. The reflector 114 is attached to the base portion 112 with the reflector 114 being freely capable of rising and falling, as depicted by an arrow mark A in FIG. 12. Further, the reflector 114 is attached to the base portion 112 with the reflector 114 being freely capable of rotating, as depicted by an arrow mark B in FIG. 13.

In FIGS. 11 through 13, illustrated is an example in which the reflection surface 114a of the reflector 114 is formed by a planar surface. Alternatively, the reflection surface 114a of the reflector 114 may be formed by a curved surface, such as a parabolic surface, and the like. Herein, it is possible that radiation patterns of the antenna 104 are arranged to be comparatively wide (broad) by forming the reflection surface 114a of the reflector 114 to have a planar surface. On the other hand, it is possible that radiation patterns of the antenna 104 are arranged to be not only comparatively narrow (sharp) but also further wide (further broad) by forming the reflection surface 114a of the reflector 114 to have a curved surface, such as a parabolic surface, and the like.

A surface of the reflection surface 114a of the reflector 114 can be formed to be even. Alternatively, at least one projection (for example, a spherical projection or a pyramidal projection) may be formed in the surface of the reflection surface 114a of the reflector 114 so that reflection efficiency may be thereby improved.

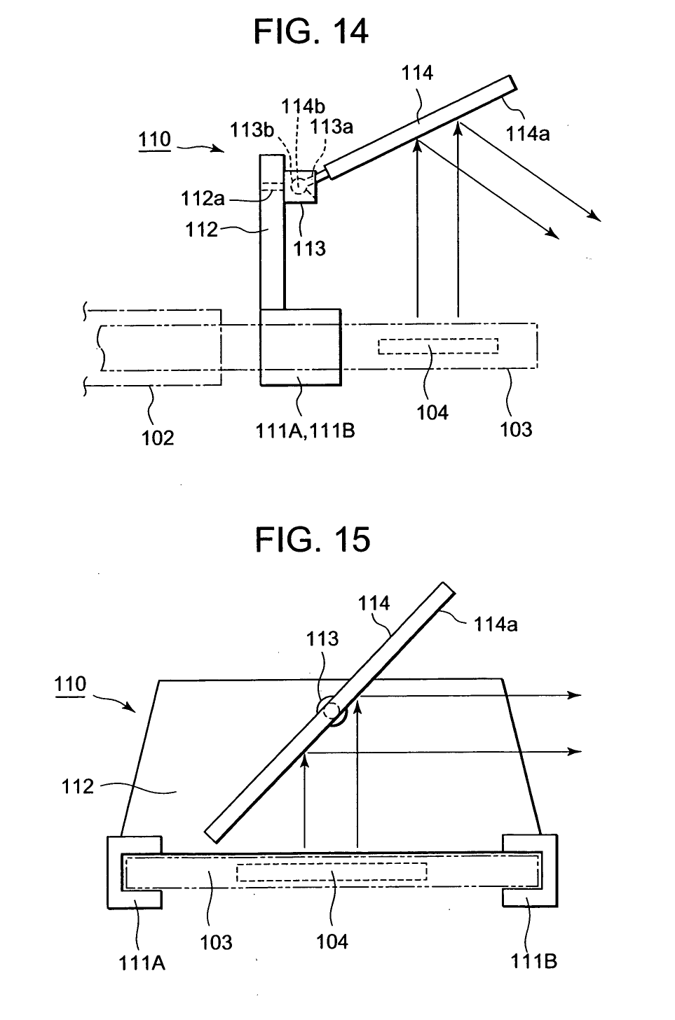

In FIG. 14, illustrated is an example of the reflector device 110 for wireless communication card according to the yet another embodiment of the present invention, by which radiation patterns of the antenna are changed to be directed downward. As illustrated in FIG. 14, by rising the reflector 114 inclined upward, radio waves radiated upward from the antenna 104 included in the wireless communication card 103 can be reflected by the reflection surface 114a of the reflector 114 and thereby directed downward. Thus, radiation patterns directed downward can be obtained by cooperating the antenna 104 and the reflector 114 with each other.

In FIG. 15, illustrated is an example of the reflector device 110 for wireless communication card according to the yet another embodiment of the present invention, by which radiation patterns of the antenna are changed to be directed sideward. As illustrated in FIG. 15, by rotating the reflector 114 inclined, radio waves radiated upward from the antenna 104 included in the wireless communication card 103 can be reflected by the reflection surface 114a of the reflector 114 and thereby directed sideward. Thus, radiation patterns directed sideward can be obtained by cooperating the antenna 104 and the reflector 114 with each other.

Further, by adequately adjusting both a rising and falling angle and a rotating angle of the reflector 114, the radiation patterns of the antenna 104 can be optionally determined in any directions.

As described above, by using the reflector device 110 according to the yet another embodiment, radiation patterns of the existing wireless communication card 103 can be changed. As a result, by adjusting the direction of the reflector 114 and thereby changing the direction of radiation patterns to an electronic apparatus of a wireless communication partner, quality of communication can be improved and thereby good communication can be carried out.

The reflector device 110 according to the yet another embodiment has a pair of attachment portions 111A and 111B capable of being attached to and removed from the existing wireless communication card 103. The reflector device 110 can be attached to the existing wireless communication card 103, when a direction of radiation patterns is required to be changed. On the other hand, when a location of a user's electronic apparatus, such as a personal computer or a location of an electronic apparatus of the wireless communication partner is changed and thereby a direction of radiation patterns is not required to be changed, the reflector device 110 can be removed from the existing wireless communication card 103.

By attaching the reflector device 110 to the existing wireless communication card 103, a reflector can be provided with an antenna included in the existing wireless communication card 103. Further, by changing a direction of the reflector 114, a direction of radiation patterns (directivity characteristics) can be changed. Namely, by adjusting the direction of the reflector 114 and thereby changing the direction of radiation patterns to an electronic apparatus of a wireless communication partner, quality of communication can be improved and thereby good communication can be carried out, without replacing the existing (old) wireless communication card 103 with a new one.

In the above-mentioned embodiments, the reflector or the reflector device as the reflecting means can not only be fixed in the housing of the wireless communication card but also be removably adapted to the housing of the wireless communication card, as described above. Accordingly, description will be hereunder made about various manners for thus removably adapting the reflector or the reflector device.

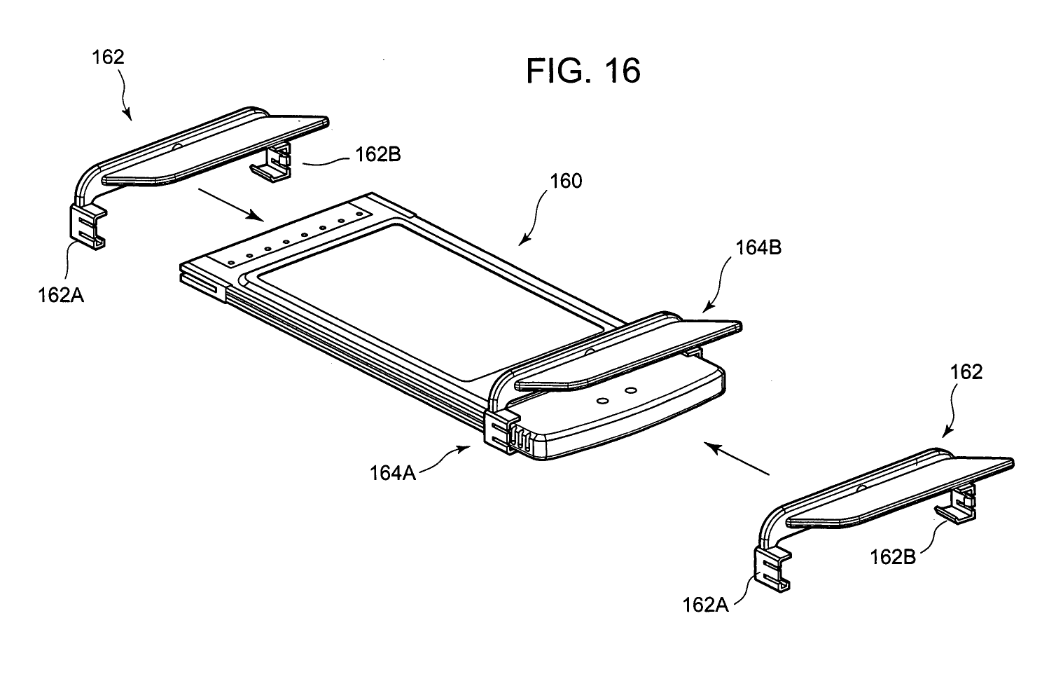

FIG. 16 shows a PC card 160 and a reflector 162 for wireless communications, where directions in which the reflector 162 is adapted to the PC card 160 are depicted. As shown in FIG. 16, the reflector 162 can be adapted to the PC card 160 from both the longitudinal directions of the PC card 160. As a result, a user of the PC card 160, or of an electronic apparatus (not shown) can insert the reflector 162 easily into the PC card 160 and fit the reflector 162 at a predetermined position thereof. Besides, the reflector 162 has a pair of attachment portions 162A and 162B. For example, the attachment portions 162A and 162B are made of elastic materials, so that the attachment portions 162A and 162B can stop at predetermined positions 164A and 164B of the PC card 160.

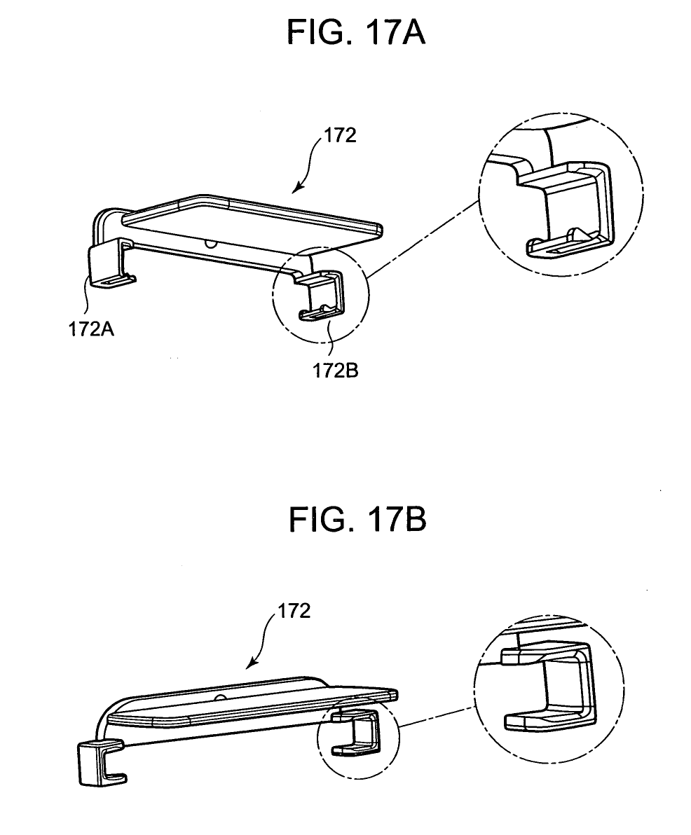

Next, referring to FIG. 17, description proceeds to various methods for adapting the reflector 162 to the PC card 160 and removing the reflector 162 from the PC card 160.

FIGS. 17A and 17B show two examples of the reflectors 172 each of which has the attachment portions 172A and 172B. In the two examples, at least a part of the respective attachment portions 172A and 172B is made of an elastic material, so that the attachment portions 172A and 172B can stop at predetermined positions of a PC card (not shown in FIGS. 17A and 17B).

In the two examples shown in FIGS. 17A and 17B, each of the reflectors 172 and a PC card (not shown in FIGS. 17A and 17B) have a stopper structure at respective corresponding positions thereof.

In FIG. 17A, as will be understood from the enlarged view of the attachment portion 172B, each of the attachment portions 172A and 172B has projections which are made of elastic materials and which function as stoppers. In a PC card (not shown), recesses corresponding to the projections are formed to receive the projections.

In FIG. 17B, each of the attachment portions 172A and 1723 is made of an elastic material, as a whole. The attachment portions 172A and 172B thereby function as stoppers. As will be understood from the enlarged view of the attachment portion 172B, the attachment portions 172A and 1723 have convex portions in at least one of the upper and the lower positions thereof, so that the attachment portions 172A and 172B thereby further function as the stoppers.

Besides, beveling or fillet (not shown) can be formed in the attachment portions 172A and 1723 at the side to which the PC card is inserted, so that the PC card is readily inserted into the attachment portions 172A and 172B.

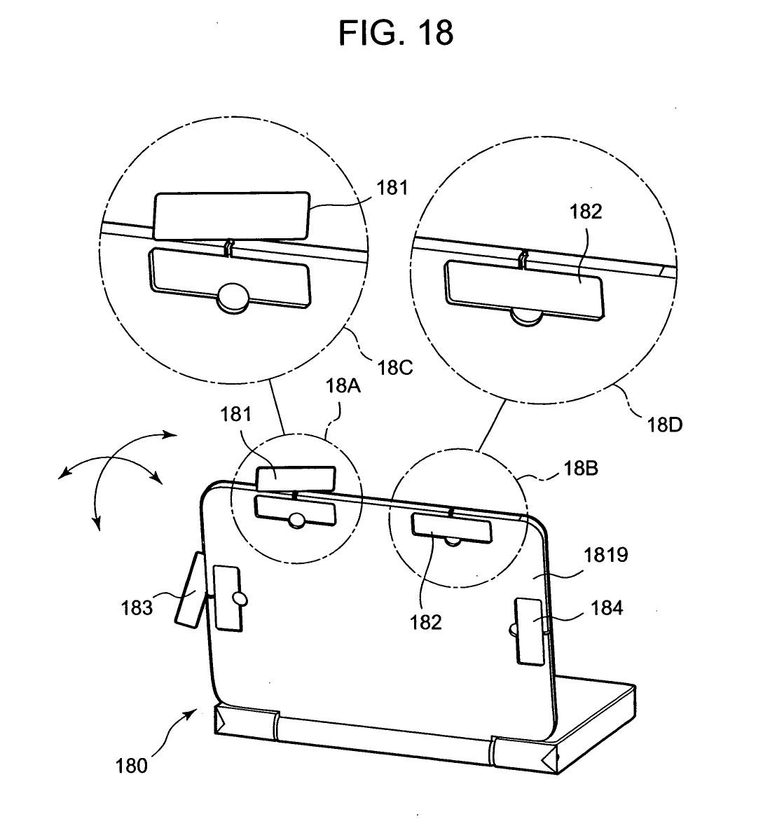

Referring to FIGS. 18 through 20, description proceeds to first through third examples of a structure that a reflector device or devices for wireless communications are contained in an electronic apparatus, such as personal computer (PC), access point (AP), printer, and the like.

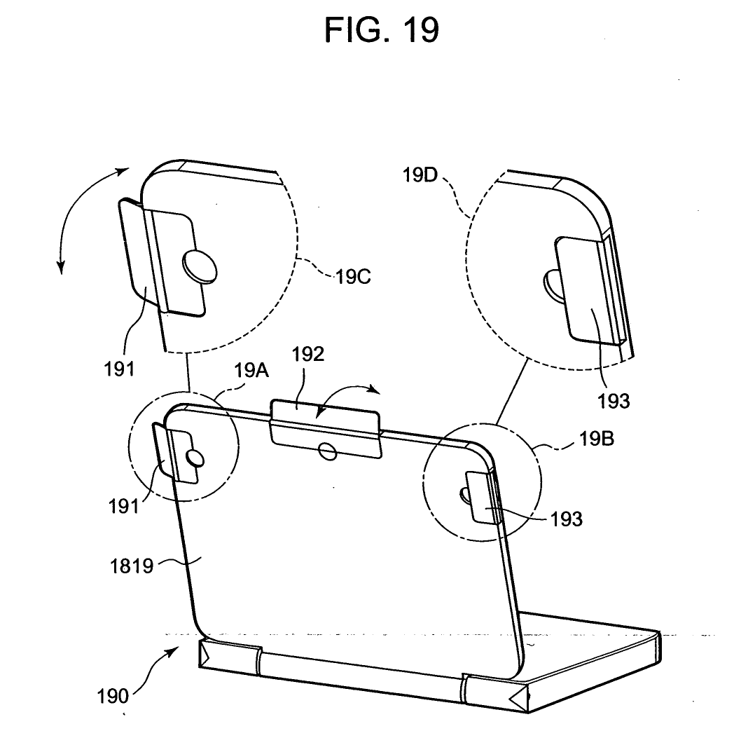

FIG. 18 shows a first example of a structure that reflector devices for wireless communications are contained in the personal computer while FIG. 19 shows a second example of a structure that reflector devices for wireless communications are contained in the personal computer. In each of the note-book type personal computers illustrated in FIGS. 18 and 19, for example, an electronic device for wireless communications (not shown) that provides the personal computer with wireless communication functions is contained in a PC card slot (not shown) of the personal computer. The electronic device for wireless communications has antennas (not shown) formed in a housing 1819 at the reverse side of a display (not shown) of the note-book type personal computer. The antennas are connected with the electronic device for wireless communications (not shown) through cables (not shown) located in the housing 1819.

With the structures of the note-book type personal computers illustrated in FIGS. 18 and 19, reflectors are incorporated in the note-book type personal computers.

At first, in FIG. 18, four reflectors 181, 182, 183, 184 are incorporated in the note-book type personal computer 180. Each of the reflectors 181, 182, 183, 184 is capable of three-dimensionally (in X-Y-Z axis) rotating around a spherical axis (pivot), as shown arrow marks in FIG. 18. In particular, as illustrated within two circles 18A, 18B depicted by alternate long and short dash lines, and also illustrated in two semi-circles 18C, 18D depicted by doted lines that are enlarged views of the circles 18A, 18B, respectively, the reflector 181 is opened to be a used condition while the reflector 182 is closed to be a contained condition. Besides, the above-mentioned antennas (not shown) are located within the housing 1819 near the reflectors 181, 182, 183, 184. Thus, the reflectors 181, 182, 183, 184 can be opened to be each used condition, when a direction of radiation patterns is required to be changed. On the other hand, when a location of the note-book type personal computer 180 or a location of an electronic apparatus of the wireless communication partner is changed and thereby a direction of radiation patterns is nor required to be changed, the reflectors 181, 182, 183, 184 can be closed to be a contained condition.

Next, in FIG. 19, three reflectors 191, 192, 193 are incorporated in the note-book type personal computer 190. Each of the reflectors 191, 192, 193 is capable of rotating around a shaft, as shown arrow marks in FIG. 19. In particular, as illustrated within two circles 19A, 19B depicted by alternate long and short dash lines, and also illustrated in two quarter-circles 19C, 19D depicted by doted lines that are enlarged views of the circles 19A, 19B, respectively, the reflector 191 is opened to be a used condition while the reflector 193 is closed to be a contained condition. Besides, the above-mentioned antennas (not shown) are located within the housing 1819 near the reflectors 191, 192, 193. Thus, the reflectors 191, 192, 193 can be opened to be each used condition, when a direction of radiation patterns is required to be changed. On the other hand, when a location of the note-book type personal computer 190 or a location of an electronic apparatus of the wireless communication partner is changed and thereby a direction of radiation patterns is not required to be changed, the reflectors 191, 192, 193 can be closed to be a contained condition.

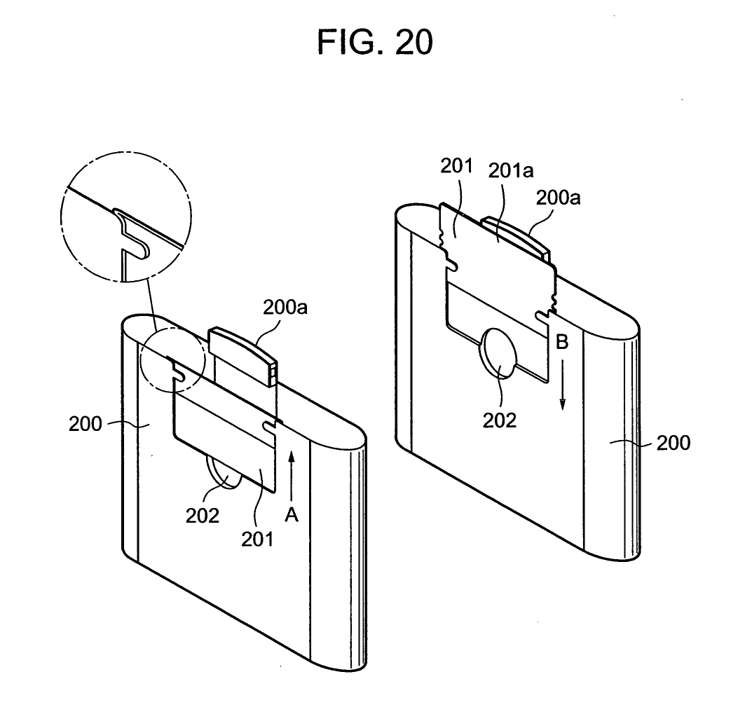

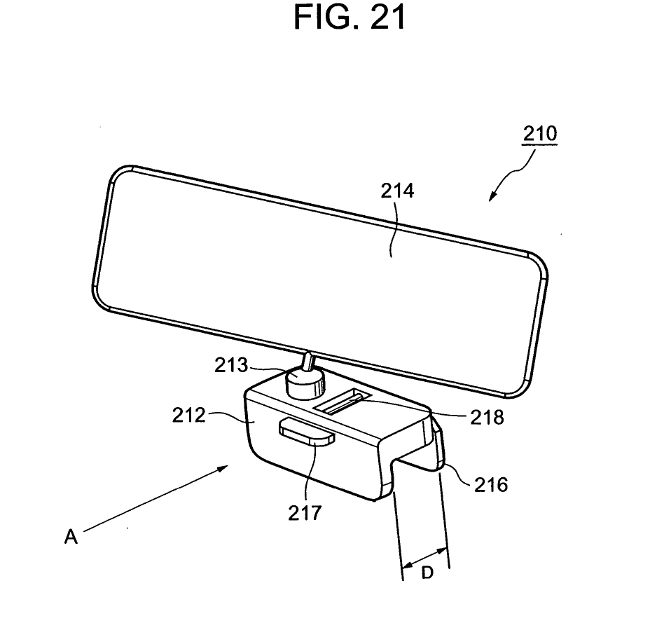

FIG. 20 shows a third example of a structure that a reflector device for wireless communications is contained in an Access Point (AP) apparatus for wireless LAN (Local Area Network) as an electronic apparatus and that the reflector device for wireless communications can be drawn from the Access Point apparatus with a slid structure thereof.

In FIG. 20, two Access Point apparatus that are the same apparatus as each other are illustrated. In an Access Point apparatus 200 illustrated in left side of the sheet of FIG. 20, a reflector 201 of a plate-shape is closed to be a contained condition. On the other hand, in an Access Point apparatus 200 illustrated in right side of the sheet of FIG. 20, the reflector 201 of the plate-shape is opened to be a used condition. Besides, a wireless communication card 200a is inserted to the Access Point apparatus 200.

In this embodiment, the reflector 201 as a reflector device is for use in a combination of the Access Point apparatus 200 as an electronic apparatus ad the wireless communication card 200a as a wireless communication card removably fitted to the Access Point apparatus 200 as the electronic apparatus so as to provide the Access Point apparatus 200 with wireless communication functions. The wireless communication card 200a includes a projecting section fitted to the Access Point apparatus 200 with an end thereof projecting from the Access Point apparatus 200, at least an antenna (not shown) arranged at the projecting section and electronically connected to a wireless circuit. On the other hand, the reflector 201 as a reflector device comprises a slid structure thereof by which the reflector 201 can be made to change positions thereof from a first position capable of reflecting the radio wave radiated from the antenna to a second position incapable of reflecting the radio wave.

To use the reflector 201, a user of the Access Point apparatus 200 can draw the reflector 201 of the plate-shape from a body (housing) of the Access Point apparatus 200 by sliding the reflector 201 of the plate-shape. For example, the user can slid the reflector 201 of the plate-shape by using his finger, namely, by inserting his finger onto a circular recess 202 and moving the finger to slid the reflector 201 of the plate-shape in the direction depicted by an arrow mark A in FIG. 20. On the contrary, to close the reflector 201, the user can return the reflector 201 of the plate-shape into the body (housing) of the Access Point apparatus 200 by siding the reflector 201 of the plate-shape. For example, the user can slid the reflector 201 of the plate-shape by using his finger, namely, by putting his finger on an end 201a and moving the finger to slid the reflector 201 of the plate-shape in the direction depicted by an arrow mark B in FIG. 20.

Thus, the reflector 201 can be drawn to be a used condition, when a direction of radiation patterns is required to be changed. On the other hand, when a direction of radiation patterns is not required to be changed, the reflector 201 can be returned to be a contained condition.

Referring to FIG. 21, description is made about a reflector device for wireless communications according to a still yet another embodiment of the present invention, in which the reflector device can be directly attached to and removed from an electronic apparatus, such as personal computer, access point apparatus, printer, and the like. As illustrated in FIG. 21, the reflector device 210 comprises a base portion 212, and a reflector 214 which is rotatably attached to the base portion 212 through a movable supporting portion 213.

The base portion 212 has a lock plate 216 as an attachment portion, a knob 217, and a compression spring 218. The lock plate 216 is pushed by the compression spring 218 to have a distance D. When the knob 217 is pushed in the direction shown by an arrow mark A in FIG. 21, for example, by a finger of a user, the lock plate 216 is moved to increase the distance D against an energisation power of the compression spring 218.

With the structure being illustrated, the reflector device 210 can be attached to and removed from the electronic apparatus, such as personal computer, access point apparatus, printer, and the like. Namely, the reflector device 210 can be attached to and removed from, for example, an upper end portion of the housing 1819 of the note-book type personal computer shown in FIG. 18. When the reflector device 210 should be attached to the upper end portion of the housing 1819 of the note-book type personal computer, the user pushes the knob 217 and make the upper end portion be interposed between the base portion 212 and the lock plate 216 with the distance D being increased. Thereafter, the user stops pushing the knob 217, so that the reflector device 210 is firmly attached to the upper end portion. Further, the reflector device 210 should be removed from the upper end portion, the user can remove the reflector device 210 by pushing the knob 217 to open the lock plate 216.

Thus, the reflector device 210 can be directly attached to and removed from an electronic apparatus with ease.

What is claimed is:

1. An electronic device for wireless communications removably fitted to an electronic apparatus so as to provide said electronic apparatus with wireless communication functions, said electronic device comprising:
a projecting section fitted to said electronic apparatus with an end thereof projecting from said electronic apparatus;
at least an antenna arranged at said projecting section and electronically connected to a wireless circuit; and
reflection means for shifting at least part of the radiating directions of a radio wave radiated from said antenna.

2. An electronic device as claimed in claim 1, wherein said reflection means can rotate around a pivot.

3. An electronic device as claimed in claim 2, wherein said reflection means can be made to change positions thereof from a first position capable of reflecting the radio wave radiated from said antenna to a second position incapable of reflecting the radio wave.

4. An electronic device as claimed in claim 2, wherein
each of bearings supporting said pivot is provided with an oblong hole adapted to rotatably support the corresponding pivot at a plurality of vertically arranged positions.

5. An electronic device as claimed in claim 1, wherein said reflection means is integral with a housing covering a mounting base board.

6. An electronic device as claimed in claim 1, wherein
said reflection means can swing in any direction around a pivot formed as a result of engagement of a spherical projection and a spherical recess.

7. An electronic device as claimed in claim 1, wherein
the reflection surface of said reflection means is curved so as to be convex or concave.

8. An electronic device as claimed in claim 1, wherein
the reflection surface of said reflection means is provided with a large number of projections.

9. An electronic device as claimed in claim 1, wherein
said antenna is arranged on the mounting base board of said projecting section and located at a position higher than a circuit mounting region where said wireless circuit is mounted.

10. An electronic device as claimed in claim 5, wherein
said reflection means is removably fitted to said housing.

11. A reflector device for use in a wireless communication card, comprising:
a base portion which has an attachment portion attached to said wireless communication card; and
a reflector which is rotatably attached to said base portion through a movable supporting portion and which reflects a radio wave.

12. A reflector device as claimed in claim 11, wherein said reflector is supported by said movable supporting portion with the reflector being freely capable of rising and falling.

13. A reflector device as claimed in claim 11, wherein a reflection surface of said reflector is formed by a planar surface.

14. A reflector device as claimed in claim 11, wherein a reflection surface of said reflector is formed by a curved surface.

15. A reflector device as claimed in claim 13, wherein at least one projection is formed in a surface of said reflection surface of said reflector device.

16. An electronic device for wireless communications contained in an electronic apparatus so as to provide said electronic apparatus with wireless communication functions, said electronic device comprising:
at least an antenna electronically connected to a wireless circuit; and
reflection means for shifting at least part of the radiating directions of a radio wave radiated from said antenna.

17. An electronic device as claimed in claim 16, wherein said reflection means can rotate around a pivot.

18. An electronic device as claimed in claim 17, wherein said reflection means can be made to change positions thereof from a first position capable of reflecting the radio wave radiated from said antenna to a second position incapable of reflecting the radio wave.

19. An electronic device as claimed in claim 16, wherein said reflection means can be drawn from said electronic apparatus with a slid structure thereof.

20. An electronic device as claimed in claim 16, wherein said reflection means is integral with a housing of said electronic apparatus.

21. An electronic device as claimed in claim 16, wherein
said reflection means can swing in any direction around a pivot formed as a result of engagement of a spherical projection and a spherical recess.

22. An electronic device as claimed in claim 16, wherein
the reflection surface of said reflection means is curved so as to be convex or concave.

23. An electronic device as claimed in claim 16, wherein
the reflection surface of said reflection means is provided with a large number of projections.

24. An electronic device as claimed in claim 16, wherein
said reflection means is removably fitted to a housing of said electronic apparatus.

25. A reflector device for use in an electronic apparatus having wireless communication functions, said reflector device comprising:
a base portion which has an attachment portion attached to said electronic apparatus; and
a reflector which is rotatably attached to said base portion through a movable supporting portion and which reflects a radio wave.

26. A reflector device as claimed in claim 25, wherein said reflector is supported by said movable supporting portion with the reflector being freely capable of-rising and falling.

27. A reflector device as claimed in claim 25, wherein a reflection surface of said reflector is formed by a planar surface.

28. A reflector device as claimed in claim 25, wherein a reflection surface of said reflector is formed by a curved surface.

29. A reflector device as claimed in claim 25, wherein at least one projection is formed in a surface of said reflection surface of said reflector device.

30. A reflector device for use in a combination of an electronic apparatus and a wireless communication card removably fitted to said electronic apparatus so as to provide said electronic apparatus with wireless communication functions, said wireless communication card including:
a projecting section fitted to said electronic apparatus with an end thereof projecting from said electronic apparatus;
at least an antenna arranged at said projecting section and electronically connected to a wireless circuit;
said reflector device comprising: a slid structure thereof by which the reflector device can be made to change positions thereof from a first position capable of reflecting the radio wave radiated from said antenna to a second position incapable of reflecting the radio wave.
